(19) United States
(12) Patent Application Publication
(10) Pub. No.: US 2025/0326175 A1
(43) Pub. Date: Oct. 23, 2025

(54) BLOW MOLDED ARTICLE OF MANUFACTURE AND METHODS OF FORMING THE SAME

(71) Applicant: GM GLOBAL TECHNOLOGY OPERATIONS LLC, Detroit, MI (US)

(72) Inventors: Sarah Tedesco, Novi, MI (US); Lora D. Herron, Commerce Township, MI (US); Charles J. Moceri, Sterling Heights, MI (US); Jared C. Harper, Lake Orion, MI (US); James S. Netherland, Clarkston, MI (US)

(73) Assignee: GM GLOBAL TECHNOLOGY OPERATIONS LLC, Detroit, MI (US)

(21) Appl. No.: 18/643,370

(22) Filed: Apr. 23, 2024

(51) Int. Cl. B29C 49/20; B29B 11/10; B29C 49/42; B29L 22/00; B29L 31/00; H01M 50/209; H01M 50/227

(52) U.S. Cl. CPC B29C 49/20; B29C 49/4278; H01M 50/209; H01M 50/227; B29B 11/10; B29C 2049/2013; B29L 2022/005; B29L 2031/7146

(57) ABSTRACT

A blow molded article of manufacture includes first and second battery enclosures each having respective first and second laterally outward extending flanges, and a parison made of a polymeric material. The first and second battery enclosure components are disposed facing each other and with their respective first and second laterally outward extending flanges registered with each other and spaced apart from each other by an offset. The parison is sandwiched between and connects together the first and second battery enclosure components, such that the parison conforms with interior surfaces of the battery enclosure components and with the parison substantially filling the offset. The article of manufacture may be cut along a cut line through the parison and within the offset around an outer perimeter of the article of manufacture, thereby separating the article of manufacture into first and second battery enclosure assemblies. Methods of formation are also disclosed.

### INTRODUCTION

This disclosure relates to blow molded articles of manufacture and to methods of forming blow molded articles of manufacture.

In electric and hybrid vehicles, a plurality of individual battery cells may be enclosed in a battery enclosure. The battery enclosure may have a metallic bottom battery tray into which the battery cells are arranged, and a metallic cover which fits over the bottom tray, with the tray and cover enclosing the battery cells.

Additionally, a polymer liner may be placed within the tray and the cover. This liner provides electrical insulation between the battery cells and the tray and cover, as well as protection against external chemicals (e.g., engine oil, road salt, etc.) and impulse events. The liner may also include dividers (between battery cells), cable management structures (for routing wires and cables) and other structures, or these dividers and structures may be provided as separate items from the liner. Further, various elastomeric or polymeric seals may be added within the battery enclosure to enhance the sealing and protection of the battery cells.

### SUMMARY

According to one embodiment, a method of forming a battery enclosure includes: (i) placing first and second battery enclosure components directly against respective first and second platens in a blow molding machine, wherein the first and second platens are disposed apart from each other in an open arrangement; (ii) suspending a parison made of polymeric material between the first and second battery enclosure components; (iii) moving at least one of the first and second platens towards the other of the first and second platens so as to dispose the first and second platens in a closed arrangement; (iv) injecting a gas into the parison so as to expand the parison into contact with the first and second battery enclosure components, thereby forming a component/parison/component assembly; (v) moving at least one of the first and second platens away from the other of the first and second platens; and (vi) removing the component/parison/component assembly from between the first and second platens.

The parison may have a first parison side and a second parison side, and in the suspending step the parison may be suspended between the first and second battery enclosure components with the first parison side facing toward the first battery enclosure component and the second parison side facing toward the second battery enclosure component. The component/parison/component assembly may include the parison attached to the first and second battery enclosure components via the first and second parison sides, respectively. In the injecting step, expansion of the parison into contact with the first and second battery enclosure components may cause the first and second parison sides to adhere to the first and second battery enclosure components, respectively.

The component/parison/component assembly may have a perimetral seam along which the first and second parison sides are attached to each other, thereby enclosing and defining an internal void within the component/parison/component assembly, with the method further including cutting the component/parison/component assembly along the perimetral seam so as to separate the parison into a first parison portion and a second parison portion and thereby dividing the component/parison/component assembly into a first battery enclosure assembly, in which the first battery enclosure component is adhered to the first parison portion, and a second battery enclosure assembly, in which the second battery enclosure component is adhered to the second parison portion. The method may further include assembling together the first and second battery enclosure assemblies to form the battery enclosure.

The first battery enclosure component may have a first bottom side and a first top side and the second battery enclosure component may have a second bottom side and a second top side, and in the placing step the first battery enclosure component may be placed with the first bottom side facing toward the first platen and the first top side facing toward the second platen, and the second battery enclosure component may be placed with the second bottom side facing toward the second platen and the second top side facing toward the first platen. At least one of the first and second battery enclosure components may be shaped as a five-sided open cover or a four-panel sleeve.

According to another embodiment, a method of forming one or more battery enclosure components includes: (i) placing a first battery enclosure component directly against a first platen in a blow molding machine having the first platen and a second platen opposing the first platen, wherein the first and second platens are disposed apart from each other in an open arrangement; (ii) suspending a parison made of polymeric material between the first battery enclosure component and the second platen; (iii) moving at least one of the first and second platens towards the other of the first and second platens so as to dispose the first and second platens in a closed arrangement; (iv) injecting a gas into the parison so as to expand the parison into contact with the first battery enclosure component and the second platen, thereby forming a component/parison assembly; (v) moving at least one of the first and second platens away from the other of the first and second platens; and (vi) removing the component/parison assembly from between the first and second platens.

The parison may have a first parison side and a second parison side, wherein in the suspending step the parison is suspended between the first battery enclosure component and the second platen with the first parison side facing toward the first battery enclosure component and the second parison side facing toward the second platen. The component/parison assembly may include the parison attached to the first battery enclosure component via the first parison side. Further, in the injecting step, expansion of the parison into contact with the first battery enclosure component may cause the first parison side to adhere to the first battery enclosure component.

The method may further include positioning a second battery enclosure component directly against the second platen, wherein the first and second platens are disposed apart from each other in the open arrangement. The second battery enclosure component may have a second bottom side and a second top side, and in the positioning step the second battery enclosure component may be positioned with the second bottom side facing toward the second platen and the second top side facing toward the first platen.

According to yet another embodiment, a blow molded article of manufacture includes: (i) a first battery enclosure component having a generally planar first major wall with the first major wall having a first major wall interior surface and a first major wall exterior surface, a first side wall extending orthogonally from and around a first outer perimeter of the first major wall with the first side wall having a first side wall interior surface and a first side wall exterior surface, and a first laterally outward extending flange extending laterally outward from the first side wall; (ii) a second battery enclosure component having a generally planar second major wall with the second major wall having a second major wall interior surface and a second major wall exterior surface, a second side wall extending orthogonally from and around a second outer perimeter of the second major wall with the second side wall having a second side wall interior surface and a second side wall exterior surface, and a second laterally outward extending flange extending laterally outward from the second side wall, wherein the first and second battery enclosure components are disposed with their respective first and second major wall interior surfaces facing each other and with their respective first and second laterally outward extending flanges registered with each other and spaced apart from each other by an offset; and (iii) a parison made of a polymeric material sandwiched between and connecting together the first and second battery enclosure components, such that the parison conforms with the first and second major wall interior surfaces and with the first and second side wall interior surfaces with the parison substantially filling the offset between the first and second laterally outward extending flanges.

The blow molded article of manufacture may further include a first orthogonally outward extending segment extending orthogonally outward from the first laterally outward extending flange, a first laterally inward extending segment extending laterally inward from the first orthogonally outward extending segment, a second orthogonally outward extending segment extending orthogonally outward from the second laterally outward extending flange, and a second laterally inward extending segment extending laterally inward from the second orthogonally outward extending segment.

The blow molded article of manufacture may further include a plurality of dividers captured between the second major wall interior surface and the parison so as to form a plurality of pockets among the plurality of dividers and the second side wall.

The blow molded article of manufacture may further include one or more cord management structures each having a respective first cord management structure end and a respective second cord management structure end, wherein the respective first and second cord management structure ends are attached to the second major wall interior surface so as to dispose each of the cord management structures in an arcuate arrangement, and wherein each of the cord management structures is captured between the second major wall interior surface and the parison with a respective passageway provided between each of the cord management structures and the second major wall interior surface.

The blow molded article of manufacture may be configured for being cut along a cut line through the parison and within the offset around an outer perimeter of the blow molded article of manufacture, thereby separating the blow molded article of manufacture into a first battery enclosure assembly and a second battery enclosure assembly.

The blow molded article of manufacture may be further configured such that the first and second battery enclosure assemblies may be disposed with their respective first and second major wall interior surfaces facing each other and with their respective first and second laterally outward extending flanges registered and in contact with each other, and such that the first and second laterally outward extending flanges may be re-attached with each other.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic elevation view of a blow molding machine.

FIGS. 2A-C are schematic cross-sectional elevation views of a first embodiment of a blow molded article of manufacture before cutting, after cutting and after re-assembly, respectively, and FIG. 2D is a schematic top view of the article of manufacture.

FIG. 3 is a schematic cross-sectional exploded view of the article of manufacture shown in FIG. 2B.

FIGS. 4A-C are schematic cross-sectional elevation views of a second embodiment of a blow molded article of manufacture before cutting, after cutting and after re-assembly, respectively.

FIGS. 5-6 are schematic perspective exploded views of two different embodiments of first and second battery enclosure components which may be used to form the blow molded article of manufacture, with no laterally outward extending flanges or second side walls being shown.

FIGS. 7-8 are schematic cross-sectional elevation views illustrating two different methods for forming a blow molded article of manufacture.

FIGS. 9A-D are schematic partially cross-sectional elevation views of first, second, third and fourth arrangements, respectively, for forming a blow molded article of manufacture.

FIG. 10 is a schematic cross-sectional elevation view of a blow molded article of manufacture having a plurality of dividers embedded therein.

FIG. 11 is a schematic cross-sectional elevation view of a selected portion of a blow molded article of manufacture having a cord management structure embedded therein.

FIGS. 12-14 are flowcharts illustrating first, second and third methods, respectively, for forming a blow molded article of manufacture.

### DETAILED DESCRIPTION

Referring now to the drawings, wherein like numerals indicate like parts in the several views, various embodiments of a blow molded article of manufacture/battery enclosure 30, and methods 100, 200, 300 for forming the article of manufacture 30 are shown and described herein.

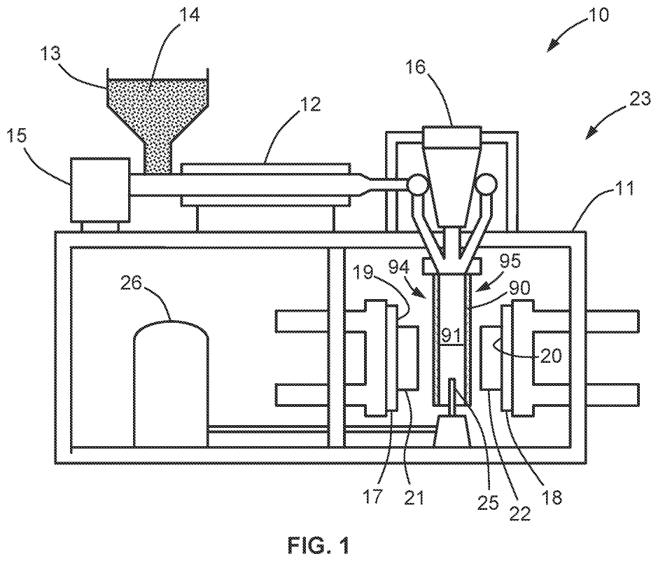

FIG. 1 shows a customary blow molding or blow forming machine 10. The machine 10 includes a frame 11 supporting an extruder 12 that is continuously fed by a hopper 13. Pellets 14 of polymeric material are placed into the hopper 13 in solid form, and an extruder drive system 15 causes the extruder 12 to rotate about its axis to feed the pellets 14 into an accumulator 16. The pellets 14 are melted within the accumulator 16 to form a viscous polymeric liquid, and the liquid polymer is then forced downward through a circular extrusion die to produce a hollow tubular parison 90 having an internal void 91 running longitudinally through the parison 90.

As the melted polymer continues to be extruded through the circular die, the parison 90 descends downward due to gravity and grows in length. The parison 90 continues to descend through a workspace that is flanked by opposing first and second platens 17, 18 having respective first and second platen surfaces 19, 20 that face each other. First and second mold halves 21, 22 are carried on the first and second platens 17, 18, respectively. The platens 17, 18 may be positioned in an open arrangement 23 as shown in FIG. 1, in which the mold halves 21, 22 are spaced away from the descending parison 90. Once the parison 90 has descended a sufficient length, the platens 17, 18 may be moved toward each other into a closed arrangement 24 (discussed further below), such that the mold halves 21, 22 press inward toward the parison 90 but only contacting the parison 90 at the top and bottom thereof. Meanwhile, a blow pin 25 extends into the internal void 91 of the parison 90, either from beneath the parison 90 as shown in FIG. 1, or from above the parison 90 (e.g., from the direction of the accumulator 16). As the platens 17, 18 and mold halves 21, 22 are pressed together into the closed arrangement 24, the mold halves 21, 22 pinch and seal the parison 90 at the top and bottom of the parison 90, with the blow pin 25 extending into the now-sealed interior/internal void 91 of the parison 90. A gas 26 (e.g., air, nitrogen) is made to flow through the blow pin 25 and into the now-sealed internal void 91, which then “inflates” the sealed volume within the parison 90 and causes the walls of the parison 90 to press against the mold halves 21, 22. This causes the previously molten parison 90 to be cooled against the relatively cooler mold halves 21, 22, thus solidifying the parison 90 and causing it to assume the shape that is milled into the mold halves 21, 22.

In contrast with the aforementioned customary approach, the blow molded article of manufacture 30, and the methods 100, 200, 300 of forming such an article 30, solve the technical problem of providing a battery enclosure which offers sealing and protecting for battery cells. This is accomplished by the technical effect of utilizing blow molding technology and specific as-molded structures as described herein, thereby providing significant benefits and technical advantages which are not taught or suggested by other approaches. These benefits and technical advantages include the use of structural elements and features, and steps in the blow molding and manufacturing process, which offer less complexity, less cost and/or higher reliability as compared to previous approaches.

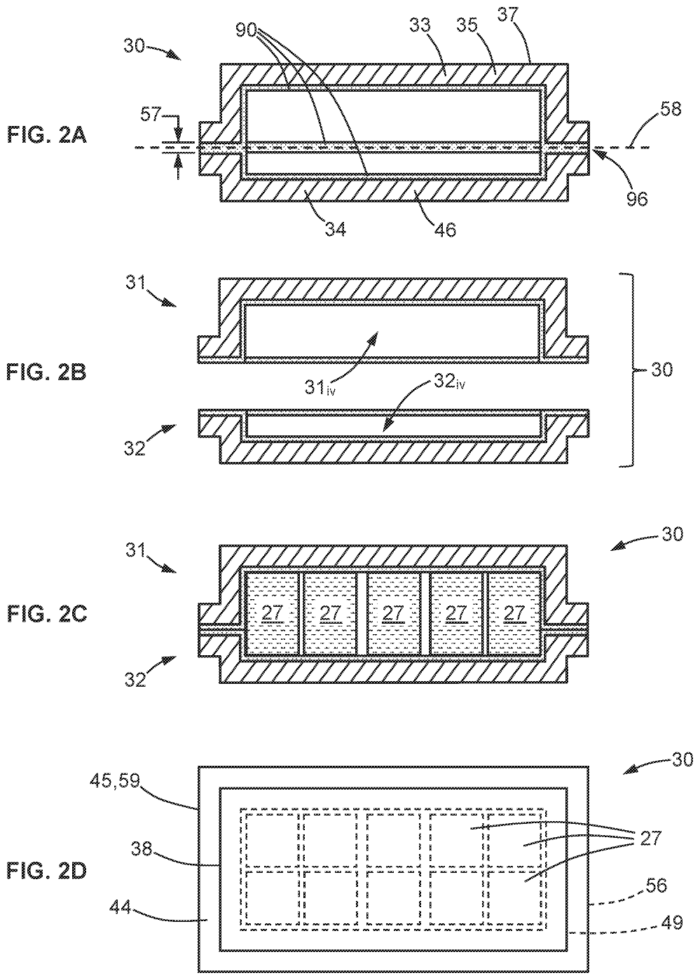

FIGS. 2A-C shows schematic cross-sectional elevation views of a first embodiment of a blow molded article of manufacture 30 which may be produced by a blow molding machine 10. More specifically, FIG. 2A shows the article of manufacture 30 as molded and before being cut, FIG. 2B shows the article of manufacture 30 after being cut and separated into first and second battery enclosure assemblies 31, 32, and FIG. 2C shows the article of manufacture 30 after being filled with battery cells 27 and after the two battery enclosure assemblies 31, 32 have been re-assembled together. Additionally, FIG. 2D shows a schematic top view of the article of manufacture 30.

As shown in FIG. 2A, this first embodiment of a blow molded article of manufacture 30 starts out with a first battery enclosure component 33 (e.g., a metallic top cover for a battery enclosure), a second battery enclosure component 34 (e.g., a metallic bottom tray for a battery enclosure), and a parison 90 sandwiched between and connecting together the first and second battery enclosure components 33, 34. (Note that while the article of manufacture 30 may be formed (i.e., blow molded) in a vertical orientation as illustrated in FIG. 1, the article of manufacture 30 is shown in FIGS. 2A-2C and others in a horizontal orientation.)

The first battery enclosure component 33 has a generally planar first major wall 35 having a first major wall interior surface 36 (in contact with the parison 90), a first major wall exterior surface 37, and a first major wall outer perimeter 38. The first battery enclosure component 33 also has a first side wall 39 which extends orthogonally (e.g., downward) from the first major wall outer perimeter 38, with the first side wall 39 also extending around the full extent of the first major wall outer perimeter 38. The first side wall 39 has a first side wall interior surface 40 (in contact with the parison 90), a first side wall exterior surface 41, a first side wall top edge or end 42 which runs around the full extent of the first major wall outer perimeter 38, and a first side wall bottom edge or end 43. The first battery enclosure component 33 also has a first laterally outward extending flange 44 extending laterally outward from the first side wall 39 (e.g., outward from the first side wall bottom edge/end 43) and having a first flange top surface 44ₜ, a first flange bottom surface 44_{b} and first flange outer perimeter 45.

The second battery enclosure component 34 has a generally planar second major wall 46 having a second major wall interior surface 47 (in contact with the parison 90), a second major wall exterior surface 48, and a second major wall outer perimeter 49. The second battery enclosure component 34 also has a second side wall 50 which extends orthogonally (e.g., upward) from the second major wall outer perimeter 49, with the second side wall 50 also extending around the full extent of the second major wall outer perimeter 49. The second side wall 50 has a second side wall interior surface 51 (in contact with the parison 90), a second side wall exterior surface 52, a second side wall top edge or end 53, and a second side wall bottom edge or end 54 which runs around the full extent of the second major wall outer perimeter 49. The second battery enclosure component 34 also has a second laterally outward extending flange 55 extending laterally outward from the second side wall 50 (e.g., outward from the second side wall top edge/end 53) and having a second flange top surface 55ₜ, a second flange bottom surface 55_{b} and a second flange outer perimeter 56.

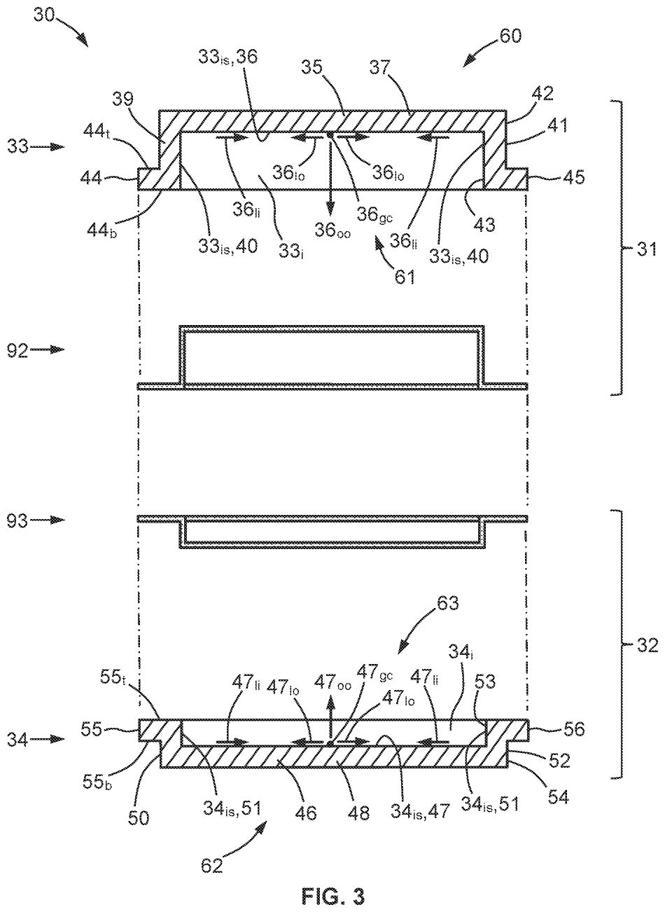

FIG. 3 shows an exploded view of the article of manufacture 30 shown in FIG. 2B. Here, the article of manufacture 30 is separated into first and second battery enclosure assemblies 31, 32, with the first battery enclosure assembly 31 being further separated into the first battery enclosure component 33 and a first parison portion 92, and with the second battery enclosure assembly 32 being further separated into the second battery enclosure component 34 and a second parison portion 93. As illustrated, the first parison portion 92 fits within the first interior 33; of the first battery enclosure component 33, and the second parison portion 93 fits within the second interior 34; of the second battery enclosure component 34. Note that while FIG. 3 shows these elements in an exploded view, this is for informational purposes only, as in reality the first parison portion 92 is intimately bonded to the first interior surface 33ᵢₛ of the first battery enclosure component 33 as a result of the blow molding process, and the second parison portion 93 is intimately bonded to the second interior surface 34ᵢₛ of the second battery enclosure component 34.

The first major wall 35 and the first side wall 39—and more specifically, the first major wall interior surface 36 and the first side wall interior surface 40—define a first interior 33ᵢ within the first battery enclosure component 33. Similarly, the second major wall 46 and the second side wall 50—and more specifically, the second major wall interior surface 47 and the second side wall interior surface 51—define a second interior 34; within the second battery enclosure component 34. The first major wall interior surface 36 and the first side wall interior surface 40 together comprise a first interior surface 33ᵢₛ within the first battery enclosure component 33, and the second major wall interior surface 47 and the second side wall interior surface 51 together comprise a second interior surface 34ᵢₛ within the second battery enclosure component 34.

The first major wall interior surface 36 has a first geometric center 36_{gc} and the second major wall interior surface 47 has a second geometric center 47_{gc}. The first major wall interior surface 36 defines a first laterally outward direction 36ₗₒ pointing away from the first geometric center 36_{gc} and running parallel with the first major wall interior surface 36, a first laterally inward direction 36ₗᵢ pointing toward the first geometric center 36_{gc} and running parallel with the first major wall interior surface 36, and a first orthogonally outward direction 36ₒₒ pointing away from the first geometric center 36_{gc} and running orthogonal (i.e., normal) to the first major wall interior surface 36. Similarly, the second major wall interior surface 47 defines a second laterally outward direction 471 pointing away from the second geometric center 47_{gc} and running parallel with the second major wall interior surface 47, a second laterally inward direction 47ₗᵢ pointing toward the second geometric center 47_{gc} and running parallel with the second major wall interior surface 47, and a second orthogonally outward direction 47ₒₒ pointing away from the second geometric center 47_{gc} and running orthogonal to the second major wall interior surface 47.

As illustrated in FIG. 2A, the first and second battery enclosure components 33, 34 are disposed with their respective first and second major wall interior surfaces 36, 47 facing each other and with their respective first and second laterally outward extending flanges 44, 55 registered or aligned with each other and spaced apart from each other by an offset or gap 57. The parison 90 is sandwiched between the first and second battery enclosure components 33, 34 and connects the first and second battery enclosure components 33, 34 together, such that the blow molded parison 90 conforms with and hugs the entirety of the first and second major wall interior surfaces 36, 47. Note that the parison 90 substantially fills the offset 57 between the first and second laterally outward extending flanges 44, 55.

In FIG. 2A, a cut line 58 is shown passing through the portions of the parison 90 that are sandwiched between the first and second laterally outward extending flanges 44, 55 within the offset 57. The blow molded article of manufacture 30 may be cut along this line 58 and around the entirety of the article's outer perimeter 59 (shown in FIG. 2D) in order to divide the article of manufacture 30 into two pieces: namely, a first battery enclosure assembly 31 and a second battery enclosure assembly 32, as illustrated in FIG. 2B. As shown, the first battery enclosure assembly 31 includes a first battery enclosure component 33 (e.g., a metallic top or cover), a first parison portion 92 that hugs the first interior surface 33ᵢₛ of the first battery enclosure component 33 (as well as hugging the first flange bottom surface 44_{b}), a first top side 60, and a first bottom side 61 that is “open” to a first interior volume 31ᵢᵥ within the first battery enclosure assembly 31. Similarly, the second battery enclosure assembly 32 includes a second battery enclosure component 34 (e.g., a metallic bottom or tray), a second parison portion 93 that hugs the second interior surface 34ᵢₛ of the second battery enclosure component 34 (as well as hugging the second flange top surface 55ₜ), a second bottom side 62, and a second top side 63 that is “open” to a second interior volume 32ᵢᵥ within the second battery enclosure assembly 32.

Once the blow molded article of manufacture 30 has been cut along the cut line 58 to separate the article 30 into two pieces, one or more battery cells 27 may be placed within the second (bottom) battery enclosure assembly 32 and the first (top) battery enclosure assembly 31 may be placed on the second battery enclosure assembly 32, thus fully containing and covering the battery cells 27.

FIG. 2C shows the article of manufacture 30 after cutting, separation, battery cell installation and re-assembly. Note that the portions of the parison 90 which previously occupied the offset 57 between the flanges 44, 55 (see FIG. 2A), and which was cut into so as to present the first and second battery enclosure assemblies 31, 32 with their respective first and second parison portions 92, 93 (see FIG. 2B), is now shown as being registered with each other and joined together. Such joining together of the previously cut portions of the parison 90 may be accomplished by various means, such as by ultrasonic joining, laser welding, chemical adhesive, mechanical fasteners and the like.

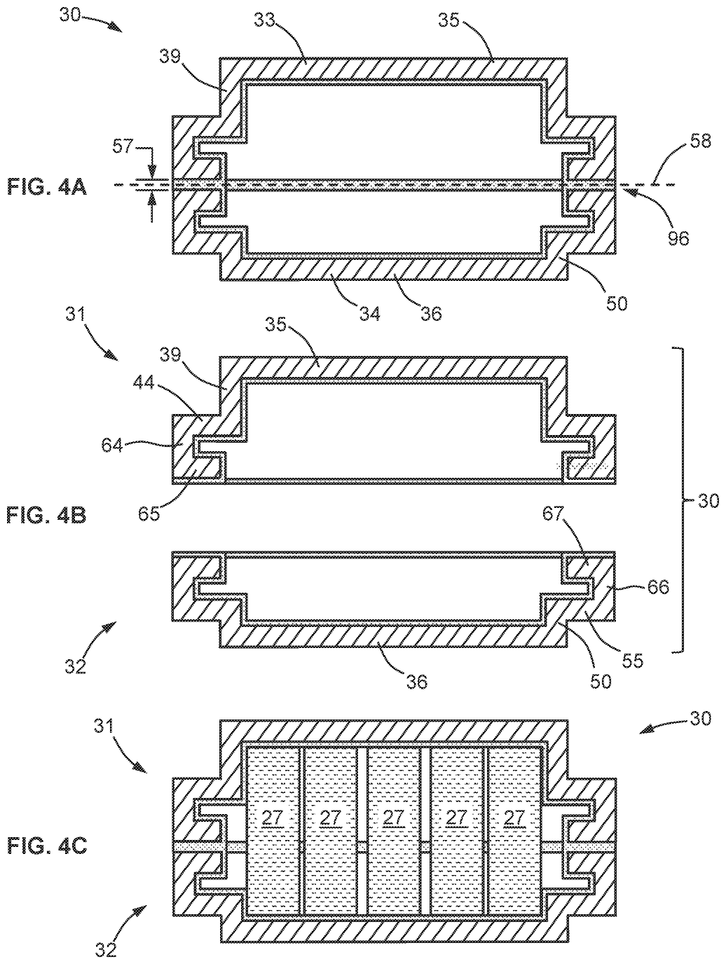

FIGS. 4A-C shows schematic cross-sectional elevation views of a second embodiment of a blow molded article of manufacture 30 which may be produced by a blow molding machine 10. More specifically, FIG. 4A shows the article of manufacture 30 as molded and before being cut, FIG. 4B shows the article of manufacture 30 after being cut and separated into first and second battery enclosure assemblies 31, 32, and FIG. 4C shows the article of manufacture 30 after being filled with battery cells 27 and after the two battery enclosure assemblies 31, 32 have been re-assembled together.

As shown in FIG. 4A, this second embodiment of a blow molded article of manufacture 30 starts out with a first battery enclosure component 33 (e.g., a metallic top cover for a battery enclosure), a second battery enclosure component 34 (e.g., a metallic bottom tray for a battery enclosure), and a parison 90 sandwiched between and connecting together the first and second battery enclosure components 33, 34, similar to the first embodiment shown in FIG. 2A. However, in the second embodiment as shown in FIG. 4A, the blow molded article of manufacture 30 may further include a first orthogonally outward extending segment 64 extending orthogonally outward from the first laterally outward extending flange 44, a first laterally inward extending segment 65 extending laterally inward from the first orthogonally outward extending segment 64, a second orthogonally outward extending segment 66 extending orthogonally outward from the second laterally outward extending flange 55, and a second laterally inward extending segment 67 extending laterally inward from the second orthogonally outward extending segment 66. Similar to the first embodiment shown in FIGS. 2A-D, the portions of the parison 90 that are sandwiched between the first and second laterally outward extending flanges 44, 55 within the offset 57 of the second embodiment may be cut along a cut line 58 so as to separate the article of manufacture 30 into first and second battery enclosure assemblies 31, 32 (see FIG. 4B), then one or more battery cells 27 may be placed in second (bottom) battery enclosure assembly 32 and the first (top) battery enclosure assembly 31 may be placed on the second battery enclosure assembly 32, thus fully containing and covering the battery cells 27, and then the first and second battery enclosure assemblies 31, 32 may be joined together (see FIG. 4C).

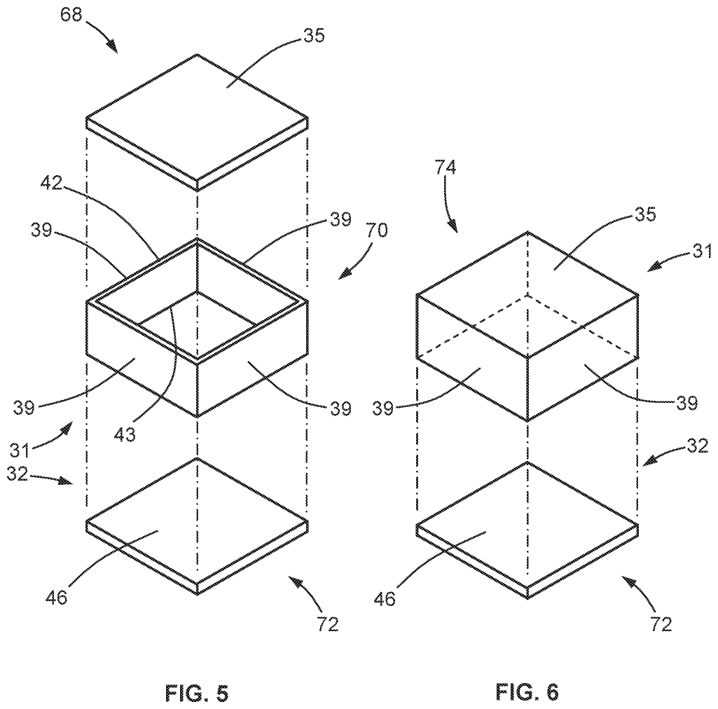

FIGS. 5 and 6 show schematic perspective exploded views of two different embodiments of the first and second battery enclosure components 33, 34 which may be used to form the blow molded article of manufacture 30. Note that in FIGS. 5-6, no laterally outward extending flanges 44, 55 or second side walls 50 are shown. In the embodiment illustrated in FIG. 5, three separate pieces are shown: a generally flat battery enclosure top/cover 68, a four-panel (or four-walled) sleeve 70 and a generally flat battery enclosure bottom/tray 72. Optionally, the battery enclosure top/cover 68 and the four-panel sleeve 70 may be manufactured separately and then joined together to form a five-sided open top/cover 74, similar to the structure shown at the top of FIG. 6. In the embodiment illustrated in FIG. 6, two separate pieces are shown: a five-sided open top/cover 74 and a generally flat battery enclosure bottom/tray 72. In either case, and as illustrated in FIGS. 5 and 6, the first battery enclosure component 31 may be joined with a corresponding second battery enclosure assembly 32 via blow molding, as described in further detail below.

As illustrated in FIGS. 5 and 6, the first side wall 39 may be made up of multiple contiguous straight walls (e.g., four contiguous walls as shown here). Alternatively, the first side wall 39 may be made up of a single wall having a circular, ellipsoidal or other rounded shape as viewed from above. Similarly, the second side wall 50 (not shown in FIGS. 5 and 6) may also be made up of multiple contiguous straight walls or one single wall. Additionally, configurations of the first and second side walls 39, 50 that are made up of multiple walls may include one or more curved walls in addition to or instead of straight walls.

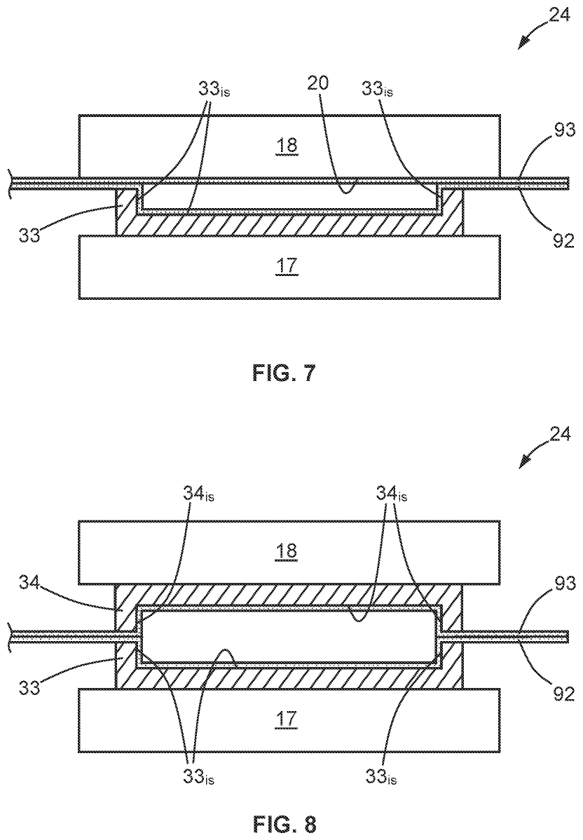

FIGS. 7-8 show schematic cross-sectional views illustrating two different methods for forming a blow molded article of manufacture 30. (Note that the views shown in FIGS. 7-8 have been rotated ninety degrees from their normal vertical orientation in order to show a horizontal orientation.) In FIG. 7, a first battery enclosure component 33 is shown placed against the first platen 17 of a blow molding machine (not shown). A parison 90 has been draped between the first battery enclosure component 33 and the second platen 18, the first and second platens 17, 18 have been pressed together, and a blow pin (not shown) has inflated the parison 90 such that a first parison portion 92 is forced into intimate contact with the first interior surface 33ᵢₛ of the first battery enclosure component 33, and a second parison portion 93 is forced into contact with the second platen surface 20. In FIG. 8, a first battery enclosure component 33 is shown placed against the first platen 17 and a second battery enclosure component 34 is shown placed against the second platen 18. A parison 90 has been draped between the first and second battery enclosure components 33, 34, the first and second platens 17, 18 have been pressed together, and the parison 90 has been inflated such that a first parison portion 92 is forced into intimate contact with the first interior surface 33ᵢₛ of the first battery enclosure component 33, and a second parison portion 93 is forced into intimate contact with the second interior surface 34ᵢₛ of the second battery enclosure component 34.

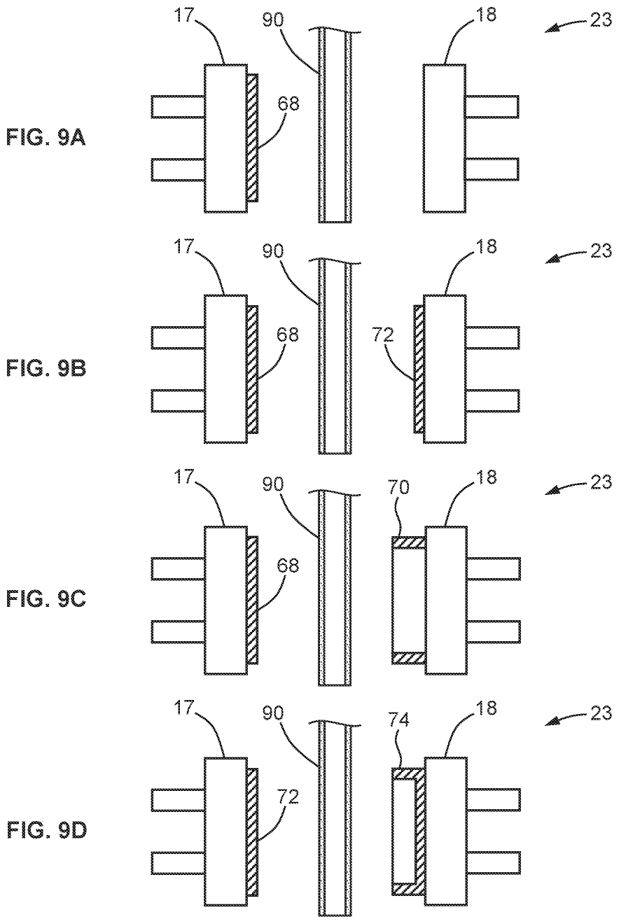

FIGS. 9A-D show first, second, third and fourth arrangements, respectively, for forming a blow molded article of manufacture 30. In each of these four views, the first and second platens 17, 18 are shown in an open arrangement 23 with a parison 90 disposed between and spaced apart from the platens 17, 18. In FIG. 9A, a single battery enclosure component, such as a battery enclosure top/cover 68 or a battery enclosure bottom/tray 72, is placed against the first platen 17. In FIG. 9B, a battery enclosure component is placed against each platen 17, 18; for example, a battery enclosure top/cover 68 may be placed against the first platen 17 and a battery enclosure bottom/tray 72 may be placed against the second platen 18. In FIG. 9C, a battery enclosure top/cover 68 is placed against the first platen 17 and a four-panel sleeve 70 is placed against the second platen 18. And in FIG. 9D, a battery enclosure bottom/tray 72 is placed against the first platen 17 and a five-sided open cover 74 is placed against the second platen 18. In addition to these four arrangements, other arrangements are also possible.

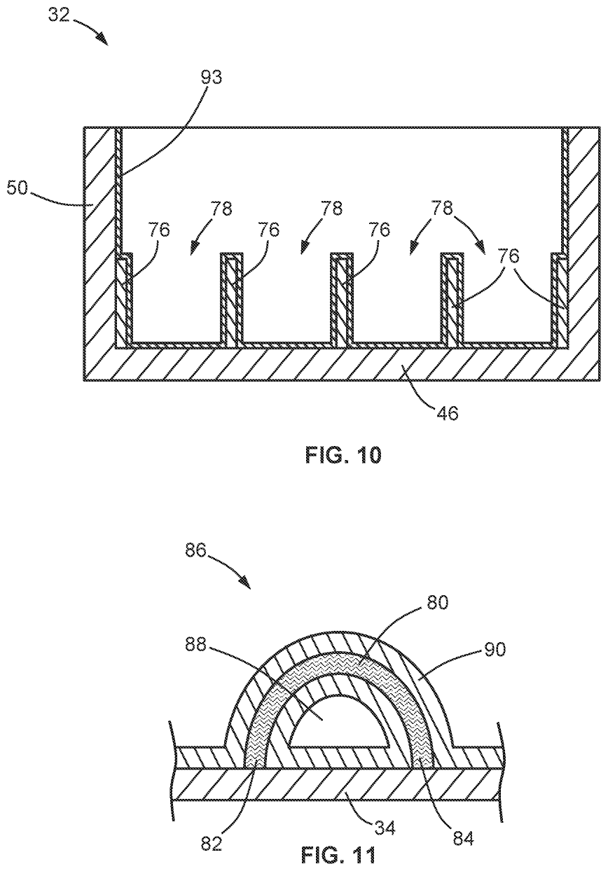

Turning now to FIG. 10, a blow molded article of manufacture 30 is again shown, but this time further including a plurality of dividers 76 captured between the second major wall interior surface 47 and the parison 90. Note that while the article of manufacture 30 is shown here in the form of the abovementioned first embodiment, the dividers 76 may be included in either of the first and second embodiments. The dividers 76 may be placed within the interior 34i of the second battery enclosure component 34, and optionally may be attached to or held against the second major wall interior surface 47 and/or the second side wall interior surface 51 prior to blow molding. (For example, the dividers 76 may be held in place by creases formed in the second major wall interior surface 47 and/or in the second side wall interior surface 51, with the dividers 76 being interference fitted into such creases.) With the dividers 76 held or attached in place, the platens 17, 18 may be moved into the closed arrangement 24 and the parison 90 may be expanded into contact with these dividers 76, so as to form a plurality of pockets 78 among the plurality of dividers 76 and the second side wall 50.

As shown in FIG. 11, the blow molded article of manufacture 30 may further include one or more cord management structures 80 each having a respective first cord management structure end 82 and a respective second cord management structure end 84. For example, the cord management structures 80 may assume the form of a tether or tow made of aramid fiber, carbon fiber or some other high-strength material. The respective first and second cord management structure ends 82, 84 are attached to the second major wall interior surface 47 so as to dispose each of the cord management structures 80 in an arcuate arrangement 86, wherein each of the cord management structures 80 is captured between the second major wall interior surface 47 and the parison 90 with a respective passageway 88 provided between each of the cord management structures 80 and the second major wall interior surface 47. Such passageways 88 may be used, for example, for passing wires and cables therethrough.

The blow molded article of manufacture 30 may be further configured such that the first and second battery enclosure assemblies 31, 32 may be disposed with their respective first and second major wall interior surfaces 36, 47 facing each other and with their respective first and second laterally outward extending flanges 44, 55 registered and in contact with each other, and such that the first and second laterally outward extending flanges 44, 55 may be re-attached with each other.

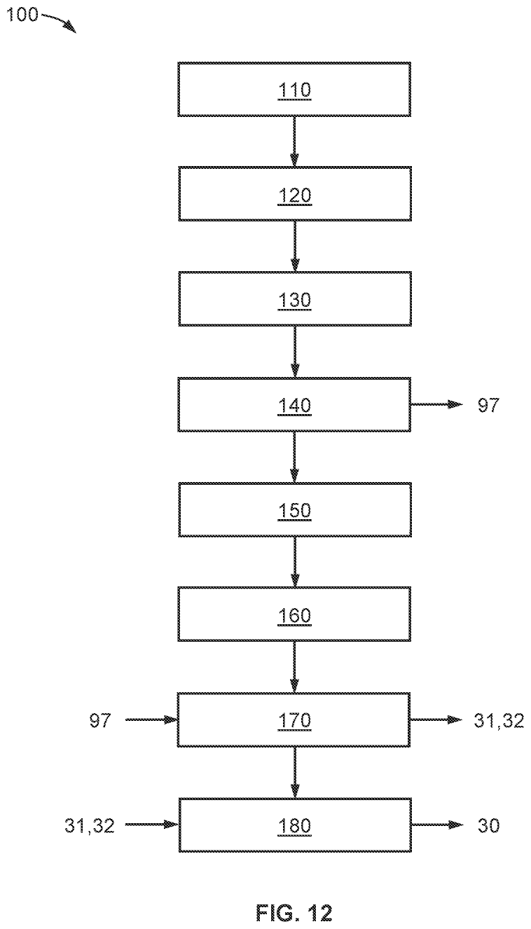

FIGS. 12-14 show flowcharts for three related but different methods 100, 200, 300 of forming an article of manufacture/battery enclosure 30 according to the present disclosure. Note that for selected steps, the inputs are shown to the left, and the results or outputs produced are shown to the right.

FIG. 12 shows a flowchart of steps for a first method 100 of forming a battery enclosure 30 in a blow molding machine 10. At step 110, first and second battery enclosure components 33, 34 are placed directly against respective first and second platens 17, 18 in a blow molding machine 10, wherein the first and second platens 17, 18 are disposed apart from each other in an open arrangement 23. At step 120, a parison 90 is suspended between the first and second battery enclosure components 33, 34. At step 130, at least one of the first and second platens 17, 18 is moved towards the other of the first and second platens 17, 18 so as to dispose the first and second platens 17, 18 in a closed arrangement 24. At step 140, a gas 26 is injected into the parison 90 via a blow pin 25 so as to expand the parison 90 and urge it into contact with the first and second battery enclosure components 33, 34, thereby forming a component/parison/component assembly 97. At step 150, at least one of the first and second platens 17, 18 is moved away from the other of the first and second platens 17, 18, and at step 160, the component/parison/component assembly 97 is removed from between the first and second platens 17, 18.

The parison 90 may have a first parison side 94 and a second parison side 95, and in the suspending step 120, the parison 90 may be suspended between the first and second battery enclosure components 33, 34 with the first parison side 94 facing toward the first battery enclosure component 33 and the second parison side 95 facing toward the second battery enclosure component 34. The component/parison/component assembly 97 may include the parison 90 attached to the first and second battery enclosure components 33, 34 via the first and second parison sides 94, 95, respectively. In the injecting step 140, expansion of the parison 90 into contact with the first and second battery enclosure components 33, 34 may cause the first and second parison sides 94, 95 to adhere to the first and second battery enclosure components 33, 34, respectively.

The component/parison/component assembly 97 may have a perimetral seam 96 along which the first and second parison sides 94, 95 are attached to each other, thereby enclosing and defining an internal void 91 within the parison 90 and the component/parison/component assembly 97. The perimetral seam 96 may optionally include a series of perforations, dimples or the like, or it may include a long seam, ridge or depression; alternatively, the perimetral seam 96 may not include any visible structures, demarcations or the like at all, and may simply be where the first and second parison sides 94, 95 have fused or welded together during the blow molding process, as illustrated in FIG. 2A. The method 100 may further include, at step 170, cutting the component/parison/component assembly 97 along the perimetral seam 96 so as to separate the parison 90 into a first parison portion 92 and a second parison portion 93 and thereby dividing the component/parison/component assembly 97 into a first battery enclosure assembly 31, in which the first battery enclosure component 33 is adhered to the first parison portion 92, and a second battery enclosure assembly 32, in which the second battery enclosure component 34 is adhered to the second parison portion 93. The method 100 may further include, at step 180, assembling together the first and second battery enclosure assemblies 31, 32 to form the battery enclosure 30.

The first battery enclosure component 33 may have a first bottom side 61 and a first top side 60, and the second battery enclosure component 34 may have a second bottom side 62 and a second top side 63, and in the placing step 110 the first battery enclosure component 33 may be placed with the first bottom side 61 facing toward the first platen 17 and the first top side 60 facing toward the second platen 18, and the second battery enclosure component 34 may be placed with the second bottom side 62 facing toward the second platen 18 and the second top side 63 facing toward the first platen 17. At least one of the first and second battery enclosure components 33, 34 may be shaped as a five-sided open top/cover 74, a four-panel sleeve 70, a generally flat battery enclosure top/cover 68 or a generally flat battery enclosure bottom/tray 72.

In some arrangements, a blow molding mold half (i.e., a first or second mold half 21, 22) is not carried by either of the first and second platens 17, 18.

The first battery enclosure component 33 has a first bottom side 61 and a first top side 60, and in the placing step 120 the first battery enclosure component 33 is placed with the first bottom side 61 facing toward the first platen 17 and the first top side 60 facing toward the second platen 18.

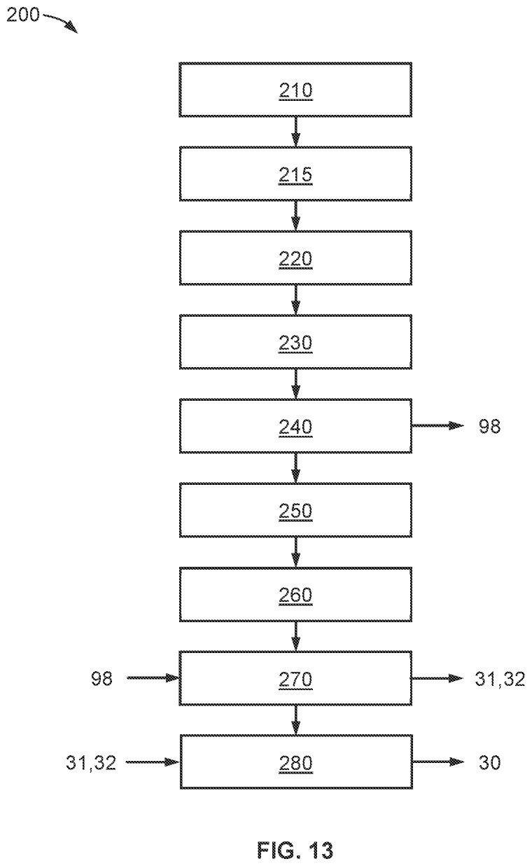

FIG. 13 shows a flowchart of steps for a second method 200 of forming a battery enclosure 30. At step 210, a first battery enclosure component 33 is placed directly against a first platen 17 in a blow molding machine 10 having the first platen 17 and a second platen 18 opposing the first platen 18, wherein the first and second platens 17, 18 are disposed apart from each other in an open arrangement 23. At step 220, a parison 90 is suspended between the first battery enclosure component 33 and the second platen 18. At step 230, at least one of the first and second platens 17, 18 is moved towards the other of the first and second platens 17, 18 so as to dispose the first and second platens 17, 18 in a closed arrangement 24. At step 240, a gas 26 is injected into the parison 90 so as to expand the parison 90 into contact with the first battery enclosure component 33 and the second platen 18, thereby forming a component/parison assembly 98. At step 250, at least one of the first and second platens 17, 18 is moved away from the other of the first and second platens 17, 18. And at step 260, the component/parison assembly 98 is removed from between the first and second platens 17, 18.

In this method 200, the parison 90 may have a first parison side 94 and a second parison side 95, and in the suspending step 220 the parison 90 may be suspended between the first battery enclosure component 33 and the second platen 18 with the first parison side 94 facing toward the first battery enclosure component 33 and the second parison side 95 facing toward the second platen 18. The component/parison assembly 98 may include the parison 90 attached to the first battery enclosure component 33 via the first parison side 94. Further, in the injecting step 240, expansion of the parison 90 into contact with the first battery enclosure component 33 may cause the first parison side 94 to adhere to the first battery enclosure component 33.

The method 200 may further include, at step 215, positioning a second battery enclosure component 34 directly against the second platen 18, wherein the first and second platens 17, 18 are disposed apart from each other in the open arrangement 23. The second battery enclosure component 34 may have a second bottom side 62 and a second top side 63, and in the positioning step 215 the second battery enclosure component 34 may be positioned with the second bottom side 62 facing toward the second platen 18 and the second top side 63 facing toward the first platen 17.

The component/parison assembly 98 may have a perimetral seam 96 along which the first and second parison sides 94, 95 are attached to each other, thereby enclosing and defining an internal void 91 within the parison 90 and the component/parison assembly 98. The method 200 may further include, at step 270, cutting the component/parison assembly 98 along the perimetral seam 96 so as to separate the parison 90 into a first parison portion 92 and a second parison portion 93 and thereby dividing the component/parison assembly 98 into a first battery enclosure assembly 31, in which the first battery enclosure component 33 is adhered to the first parison portion 92, and a second battery enclosure assembly 32, in which the second battery enclosure component 34 is adhered to the second parison portion 93. The method 200 may further include, at step 280, assembling together the first and second battery enclosure assemblies 31, 32 to form the battery enclosure 30.

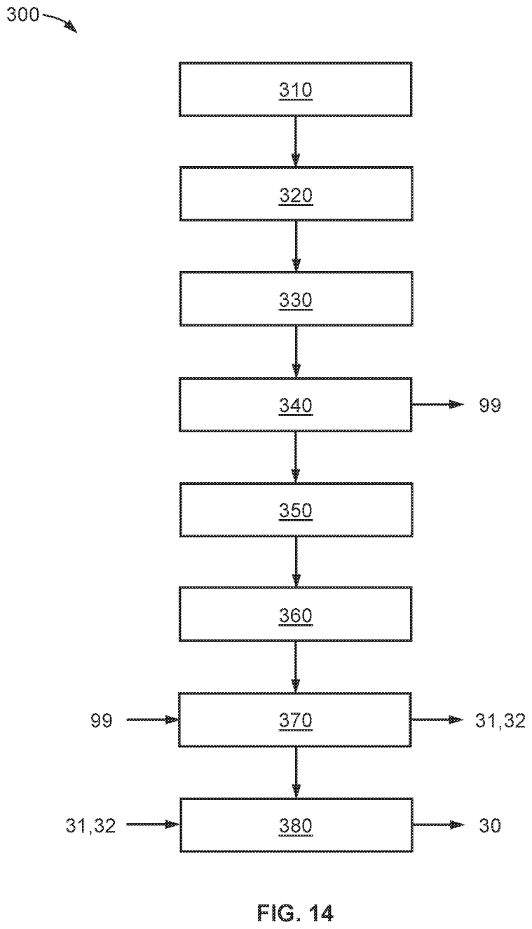

FIG. 14 shows a flowchart of steps for a third method 300 of blow molding in a blow molding machine 10 having opposed first and second platens 17, 18. At step 310, a generally flat battery tray (i.e., either a battery enclosure top/cover 68 or a battery enclosure bottom/tray 72) is placed directly against the first platen 17, wherein the first and second platens 17, 18 are disposed apart from each other in an open arrangement 23, and wherein a blow molding mold half 21, 22 is not carried by the first platen 17. At step 320, a parison 90 is suspended between the battery tray 68, 72 and the second platen 18. At step 330, at least one of the first and second platens 17, 18 is moved towards the other of the first and second platens 17, 18 so as to dispose the first and second platens 17, 18 in a closed arrangement 24. At step 340, a gas 26 is injected into the parison 90 so as to expand the parison 90 into contact with the battery tray 68, 72 and the second platen 18, thereby forming a battery tray/parison assembly 99. At step 350, at least one of the first and second platens 17, 18 is moved away from the other of the first and second platens 17, 18. And at step 360, the battery tray/parison assembly 99 is removed from between the first and second platens 17, 18.

The battery tray/parison assembly 99 may have a perimetral seam 96 along which the first and second parison sides 94, 95 are attached to each other, thereby enclosing and defining an internal void 91 within the parison 90 and the battery tray/parison assembly 99. The method 300 may further include, at step 370, cutting the battery tray/parison assembly 99 along the perimetral seam 96 so as to separate the parison 90 into a first parison portion 92 and a second parison portion 93 and thereby dividing the battery tray/parison assembly 99 into a first battery enclosure assembly 31, in which the first battery enclosure component 33 is adhered to the first parison portion 92, and a second battery enclosure assembly 32, in which the second battery enclosure component 34 is adhered to the second parison portion 93. The method 300 may further include, at step 380, assembling together the first and second battery enclosure assemblies 31, 32 to form the battery enclosure 30.

The blow molded article of manufacture 30 may be used for a variety of different purposes, including but not limited to various automotive vehicle applications. For example, the article 30 may be used as a housing or container for one or more battery cells 27 or fuel cells in a hybrid or non-hybrid vehicle, including an electric vehicle. The article 30 may also be used to house or contain other items, components or sub-systems, such as electrical fuse blocks, intake air filter systems, cabin air filtration systems, etc.

While various steps of the methods 100, 200, 300 have been described as being separate blocks, and various parts of the blow molded article of manufacture 30 have been described as being separate elements, it may be noted that two or more steps may be combined into fewer blocks, and two or more parts may be combined into fewer elements. Similarly, some steps described as a single block may be separated into two or more blocks, and some parts described as a single element may be separated into two or more elements. Additionally, the order of the steps or blocks described herein may be rearranged in one or more different orders, and the arrangement of the parts and elements may be rearranged into one or more different arrangements.

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A method of forming a battery enclosure, comprising:
placing first and second battery enclosure components directly against respective first and second platens in a blow molding machine, wherein the first and second platens are disposed apart from each other in an open arrangement;
suspending a parison made of polymeric material between the first and second battery enclosure components;
moving at least one of the first and second platens towards the other of the first and second platens so as to dispose the first and second platens in a closed arrangement;
injecting a gas into the parison so as to expand the parison into contact with the first and second battery enclosure components, thereby forming a component/parison/component assembly;
moving at least one of the first and second platens away from the other of the first and second platens; and
removing the component/parison/component assembly from between the first and second platens.

2. The method of claim 1, wherein the parison has a first parison side and a second parison side, and wherein in the suspending step the parison is suspended between the first and second battery enclosure components with the first parison side facing toward the first battery enclosure component and the second parison side facing toward the second battery enclosure component.

3. The method of claim 2, wherein the component/parison/component assembly comprises the parison attached to the first and second battery enclosure components via the first and second parison sides, respectively.

4. The method of claim 3, wherein in the injecting step, expansion of the parison into contact with the first and second battery enclosure components causes the first and second parison sides to adhere to the first and second battery enclosure components, respectively.

5. The method of claim 2, wherein the component/parison/component assembly has a perimetral seam along which the first and second parison sides are attached to each other, thereby enclosing and defining an internal void within the component/parison/component assembly, the method further comprising:
cutting the component/parison/component assembly along the perimetral seam so as to separate the parison into a first parison portion and a second parison portion and thereby dividing the component/parison/component assembly into:
a first battery enclosure assembly in which the first battery enclosure component is adhered to the first parison portion; and
a second battery enclosure assembly in which the second battery enclosure component is adhered to the second parison portion.

6. The method of claim 5, further comprising:
assembling together the first and second battery enclosure assemblies to form the battery enclosure.

7. The method of claim 1, wherein the first battery enclosure component has a first bottom side and a first top side and the second battery enclosure component has a second bottom side and a second top side, and wherein in the placing step:
the first battery enclosure component is placed with the first bottom side facing toward the first platen and the first top side facing toward the second platen; and
the second battery enclosure component is placed with the second bottom side facing toward the second platen and the second top side facing toward the first platen.

8. The method of claim 1, wherein at least one of the first and second battery enclosure components is shaped as a five-sided open cover or a four-panel sleeve.

9. A method of forming one or more battery enclosure components, comprising:
placing a first battery enclosure component directly against a first platen in a blow molding machine having the first platen and a second platen opposing the first platen, wherein the first and second platens are disposed apart from each other in an open arrangement;
suspending a parison made of polymeric material between the first battery enclosure component and the second platen;
moving at least one of the first and second platens towards the other of the first and second platens so as to dispose the first and second platens in a closed arrangement;
injecting a gas into the parison so as to expand the parison into contact with the first battery enclosure component and the second platen, thereby forming a component/parison assembly;
moving at least one of the first and second platens away from the other of the first and second platens; and
removing the component/parison assembly from between the first and second platens.

10. The method of claim 9, wherein the parison has a first parison side and a second parison side, and wherein in the suspending step the parison is suspended between the first battery enclosure component and the second platen with the first parison side facing toward the first battery enclosure component and the second parison side facing toward the second platen.

11. The method of claim 10, wherein the component/parison assembly comprises the parison attached to the first battery enclosure component via the first parison side.

12. The method of claim 11, wherein in the injecting step, expansion of the parison into contact with the first battery enclosure component causes the first parison side to adhere to the first battery enclosure component.

13. The method of claim 9, further comprising:
positioning a second battery enclosure component directly against the second platen, wherein the first and second platens are disposed apart from each other in the open arrangement.

14. The method of claim 13, wherein the second battery enclosure component has a second bottom side and a second top side, and wherein in the positioning step the second battery enclosure component is positioned with the second bottom side facing toward the second platen and the second top side facing toward the first platen.

15. A blow molded article of manufacture, comprising:
a first battery enclosure component having a generally planar first major wall with the first major wall having a first major wall interior surface and a first major wall exterior surface, a first side wall extending orthogonally from and around a first outer perimeter of the first major wall with the first side wall having a first side wall interior surface and a first side wall exterior surface, and a first laterally outward extending flange extending laterally outward from the first side wall;
a second battery enclosure component having a generally planar second major wall with the second major wall having a second major wall interior surface and a second major wall exterior surface, a second side wall extending orthogonally from and around a second outer perimeter of the second major wall with the second side wall having a second side wall interior surface and a second side wall exterior surface, and a second laterally outward extending flange extending laterally outward from the second side wall, wherein the first and second battery enclosure components are disposed with their respective first and second major wall interior surfaces facing each other and with their respective first and second laterally outward extending flanges registered with each other and spaced apart from each other by an offset; and
a parison made of a polymeric material sandwiched between and connecting together the first and second battery enclosure components, such that the parison conforms with the first and second major wall interior surfaces and with the first and second side wall interior surfaces with the parison substantially filling the offset between the first and second laterally outward extending flanges.

16. The blow molded article of manufacture of claim 15, further comprising:
a first orthogonally outward extending segment extending orthogonally outward from the first laterally outward extending flange, and a first laterally inward extending segment extending laterally inward from the first orthogonally outward extending segment; and
a second orthogonally outward extending segment extending orthogonally outward from the second laterally outward extending flange, and a second laterally inward extending segment extending laterally inward from the second orthogonally outward extending segment.

17. The blow molded article of manufacture of claim 15, further comprising:
a plurality of dividers captured between the second major wall interior surface and the parison so as to form a plurality of pockets among the plurality of dividers and the second side wall.

18. The blow molded article of manufacture of claim 15, further comprising:
one or more cord management structures each having a respective first cord management structure end and a respective second cord management structure end, wherein the respective first and second cord management structure ends are attached to the second major wall interior surface so as to dispose each of the cord management structures in an arcuate arrangement, and wherein each of the cord management structures is captured between the second major wall interior surface and the parison with a respective passageway provided between each of the cord management structures and the second major wall interior surface.

19. The blow molded article of manufacture of claim 15, wherein the blow molded article of manufacture is configured for being cut along a cut line through the parison and within the offset around an outer perimeter of the blow molded article of manufacture, thereby separating the blow molded article of manufacture into a first battery enclosure assembly and a second battery enclosure assembly.

20. The blow molded article of manufacture of claim 19, wherein the blow molded article of manufacture is further configured such that the first and second battery enclosure assemblies may be disposed with their respective first and second major wall interior surfaces facing each other and with their respective first and second laterally outward extending flanges registered and in contact with each other, and such that the first and second laterally outward extending flanges may be re-attached with each other.
